(19) United States
(12) Patent Application Publication
(10) Pub. No.: US 2024/0428063 A1
(43) Pub. Date: Dec. 26, 2024

(54) NEUROMORPHIC OPTICAL COMPUTING ARCHITECTURE SYSTEM AND APPARATUS

(71) Applicant: TSINGHUA UNIVERSITY, Beijing (CN)

(72) Inventors: Lu FANG, Beijing (CN); Yuan CHENG, Beijing (CN)

(21) Appl. No.: 18/749,144

(22) Filed: Jun. 20, 2024

(30) Foreign Application Priority Data
Jun. 20, 2023 (CN) 202310735709.5

(51) Int. Cl. G06N 3/067; G06N 3/04

(52) U.S. Cl. CPC G06N 3/067; G06N 3/04

(57) ABSTRACT

A neuromorphic optical computing architecture system includes: a multi-channel representation module, configured to encode, via a multi-spectral laser, an originally inputted target light field signal into coherent light having different wavelengths; an attention-aware optical neural network module including a bottom-up (BU) optical attention module and a top-down (TD) optical attention module, in which the coherent light having different wavelengths is input to the BU optical attention module and network training is performed on an attention-aware optical neural network, and the TD optical attention module performs, based on the trained attention-aware optical neural network, spectral and spatial transmittance modulation of multi-dimensional sparse features extracted by the BU optical attention module to obtain a final spatial light output; and an output module configured to detect and identify the final spatial light output on an output plane to obtain a location of an object in a light field and an identification result.

### CROSS REFERENCE TO RELATED APPLICATIONS

This application claims priority to Chinese Patent Application No. 202310735709.5, filed Jun. 20, 2023, the entire disclosure of which is incorporated by reference herein.

### TECHNICAL FIELD

The disclosure relates to the field of neuromorphic computing technology, in particular to a neuromorphic optical computing architecture system and a neuromorphic optical computing architecture apparatus.

### BACKGROUND

Artificial intelligence has been in development for some time and is widely used for applications such as machine vision, autonomous driving and intelligent robotics. Modern machine intelligence tasks require complex algorithms and large-scale computations, which leads to a growing demand for computing resources.

### SUMMARY

A first aspect of the disclosure provides a neuromorphic optical computing architecture system. The system includes: a multi-channel representation module, an attention-aware optical neural network module and an output module.

The multi-channel representation module is configured to encode, via a multi-spectral laser, an originally inputted target light field signal into coherent light having different wavelengths.

The attention-aware optical neural network module includes: a bottom-up (BU) optical attention module and a top-down (TD) optical attention module, in which the coherent light having different wavelengths as input to the BU optical attention module and network training is performed on an attention-aware optical neural network, and the TD optical attention module performs, based on the trained attention-aware optical neural network, spectral and spatial transmittance modulation on multi-dimensional sparse features extracted by the BU optical attention module to obtain a final spatial light output.

The output module is configured to detect and identify the final spatial light output on an output plane to obtain a location of an object in a light field and an identification result.

A second aspect of the disclosure provides a neuromorphic optical computing architecture apparatus. The apparatus includes: a multispectral laser, a beam splitter, a reflector, a lens, a first BU optical attention module, a second BU optical attention module, an optical filter, a TD optical attention module, and an intensity sensor.

A target light field signal is input to the multispectral laser to output coherent light having different wavelengths; diffraction-based light propagation of the coherent light having different wavelengths is guided using the beam splitter, the reflector and the lens; after propagation, the TD optical attention module takes a multidimensional sparse feature output by the first BU optical attention module as input, processes the input and feeds back to the second BU optical attention module to adjust the second BU optical attention module; the optical filter is used to control connections between optical neurons in the second BU optical attention module and perform spectral and spatial modulation on the optical neurons; and the intensity sensor is used to detect and obtain a location of an object in a light field and an identification result based on light attention factors.

### BRIEF DESCRIPTION OF THE DRAWINGS

The foregoing and/or additional aspects and advantages of embodiments of the disclosure will become apparent and more readily appreciated from the following descriptions made with reference to the accompanying drawings.

FIG. 1 is a schematic diagram illustrating a neuromorphic optical computing architecture system according to an embodiment of the disclosure.

FIG. 2 is a schematic diagram illustrating a neuromorphic optical computing architecture of an attention-aware optical neural network (AttnONN) according to an embodiment of the disclosure.

FIG. 3 is a schematic diagram illustrating a metasurface-based optical filter according to an embodiment of the disclosure.

FIG. 4 is a schematic diagram illustrating performance evaluation of the AttnONN on a target detection task according to an embodiment of the disclosure.

FIG. 5 is a schematic diagram illustrating the AttnONN working on a 3D object classification task according to an embodiment of the disclosure.

FIG. 6 is a schematic diagram illustrating a neuromorphic optical computing architecture apparatus according to an embodiment of the disclosure.

### DETAILED DESCRIPTION

It is noted that embodiments and the features in embodiments of the disclosure may be combined with each other without conflict. The disclosure will be described in detail below with reference to the accompanying drawings and in combination with the embodiments.

In order to enable those skilled in the art to better understand embodiments of the disclosure, the technical solutions in embodiments of the disclosure will be described clearly and fully in the following in combination with the accompanying drawings in embodiments of the disclosure. Obviously, the described embodiments are only a part of the embodiments of the disclosure and not all of the embodiments. Based on embodiments of the disclosure, other embodiments obtained by those skilled in the art without inventive works shall fall within the scope of protection of the disclosure.

Light-based neuromorphic computing demonstrates its potential for parallel computing with high efficiency. The existing optical architectures pursue higher capability by applying dense optical neuron connections and simply enlarging or deepening network, and thus the network becomes highly complex and redundant, which is only suitable for solving simple tasks. However, human brain may perform a highly-efficient analysis on a variety of complex tasks by using event-driven attention mechanisms and sparse neuron connections.

Artificial intelligence has been in development for some time and is widely used for applications such as machine vision, autonomous driving and intelligent robotics. Modern machine intelligence tasks require complex algorithms and large-scale computations, which leads to a growing demand for computing resources. With Moore's Law stagnating, the issue of energy efficiency has become a major obstacle for electron-based neural networks, which may hinder broader application of today's AI technologies. Recently, optical neural networks (ONNs), which use light rather than electricity for computation, have demonstrated their potential as a next-generation computational paradigm due to inherent high speed and highly efficient propagation of light. Small-sized all-optical systems have been successfully validated for basic visual processing tasks such as handwritten digit identification and significance testing. Deep Optics, Fourier neural networks, and hybrid optoelectronic CNNs integrate electronic elements into optical architectures to enhance ordinary ONNs. Other works multiplex optical computing units in an attempt to handle larger input and obtain better performance. Essentially, these approaches maintain the originally densely-arranged optical neuron connections by simply enlarging or deepening networks in pursuit of higher capabilities, which unfortunately leads to severe computational redundancy and renders optical networks incapable of accomplishing high-level real-world tasks. By contrary, human brain employs event-driven attentional mechanisms that applies spectral and spatial sparse neuron connections to perform general-purpose complex tasks by means of extremely highly-efficient parallel computations. In fact, optical computing, with its inherent sparsity and parallelism due to a large amount of optical connections, may naturally propagate features of biological neurons to optical neurons.

The disclosure proposes a neuromorphic optical computing architecture system, provides an attention-aware optical neural network (AttnONN), or an optical network architecture employing spectral and spatial sparse optical convolution layers, in which optical neurons are activated only when there is a signal to be processed. The AttnONN may adaptively allocate computational resources, providing unprecedented capability and scalability, and the disclosure utilizes an optical neural network to solve high-complexity machine learning problems. Experimental results confirm the high performance and high efficiency of the AttnONN on a variety of challenging tasks, with an 8-times improvement in learning capacity compared to original optical networks, and an efficiency more than 2 times higher than that of a representative electrical neural network (e.g., ResNet-18).

A neuromorphic optical computing architecture system and a neuromorphic optical computing architecture apparatus according to embodiments of the disclosure will be described below with reference to the accompanying drawings.

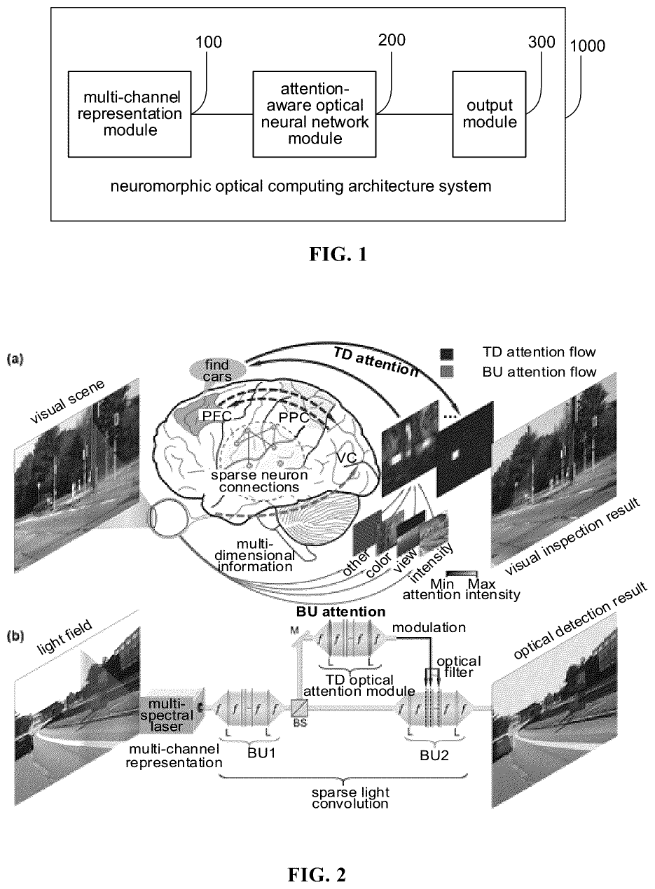

FIG. 1 is a schematic diagram illustrating a neuromorphic optical computing architecture system 1000 according to an embodiment of the disclosure.

As illustrated in FIG. 1, the system 1000 includes: a multi-channel representation module 100, an attention-aware optical neural network module 200 and an output module 300.

The multi-channel representation module 100 is configured to encode, via a multi-spectral laser, an originally inputted target light field signal into coherent light having different wavelengths.

The attention-aware optical neural network module 200 includes: a bottom-up (BU) optical attention module and a top-down (TD) optical attention module, in which the coherent light having different wavelengths is input to the BU optical attention module and network training is performed on an attention-aware optical neural network, and the TD optical attention module performs, based on the trained attention-aware optical neural network, spectral and spatial transmittance modulation of multi-dimensional sparse features extracted by the BU optical attention module to obtain a final spatial light output.

The output module 300 is configured to detect and identify the final spatial light output on an output plane to obtain a location of an object in a light field and an identification result.

FIG. 2 is a schematic diagram illustrating a neuromorphic optical computing architecture according to an embodiment of the disclosure, in which (a) shows visual BU and TD attention flows in the human brain. The BU attention flow converts original sensory input into distinguishing features of potential importance, e.g., prominent regions in the background. The TD attention flow biases the BU attention to priori knowledge based on long-term cognition, e.g., car searching. The TD and BU attention flows together focus attention on a target location and identify its category. In FIG. 2, (b) shows a layered optical neuromorphic structure of an attention-aware optical neural network (AttnONN). The BU optical attention module extracts multidimensional sparse features of different wavelengths. The TD optical attention module performs spectral and spatial transmittances modulation of BU attention to obtain a location of an object in the light field and an identification result.

It is understandable that human visual system relies on two distinct attention processes. As illustrated in (a) of FIG. 2, the internal process happens in the brain depict a cerebral cortex pathway involved in visual attention, and the external process illustrates integration of corresponding BU and TD computing stages. In detail, the visual scene captured by the eyes together with its multidimensional information (e.g., color, view, or intensity) are sent to the sparsely neuronally-connected prefrontal cortex (PFC), posterior parietal cortex (PPC) and visual cortex (VC) for processing. The BU attention flow may be modulated by the TD attention flow to current behavioral goals and prior knowledge. The final attention is focused on the most prominent activity/object location in the visual scene, which may be used for reasoning in high-level semantic tasks, such as visual detection. In processing, neuronal connections in the attention flow are sparse and in parallel, and nerve synapses only act when there is a relevant signal to be processed.

In an embodiment of the disclosure, the architecture of the AttnONN is illustrated in (b) of FIG. 2. Multi-channel representations of the input signal are encoded to different wavelengths in the light field and are split into TD and BU branches. A multispectral laser, a beam splitter (BS), a mirror (M), and a lens (L) are used to generate and guide diffraction-based light propagation. The BU and TD optical attention modules are established by inserting sparse optical convolution units into a Fourier plane of an 4f optical system under the coherent light. The sparse optical convolution units are formed by stacking multiple layers, where each layer transmits sparse features as input to the next layer. The TD optical attention module takes the output features of the BU optical attention module 1 (BU1) as input, processes the input and feeds back to the BU optical attention module 2 (BU2) to adjust the BU2.

The TD output controls the connections between optical neuron in the BU2 via a metasurface-based optical filter, and the spectral and spatial modulations are performed simultaneously. In combination with optical attention factors U_{bu1}, U_{td} and U_{bu2}, the final result may be obtained through detection on the output plane using the intensity sensor. In an example, the architectural network provided in the disclosure is set up to use wavelengths ranging from 500 to 1500 nm, which provides a wide range for spectral selection.

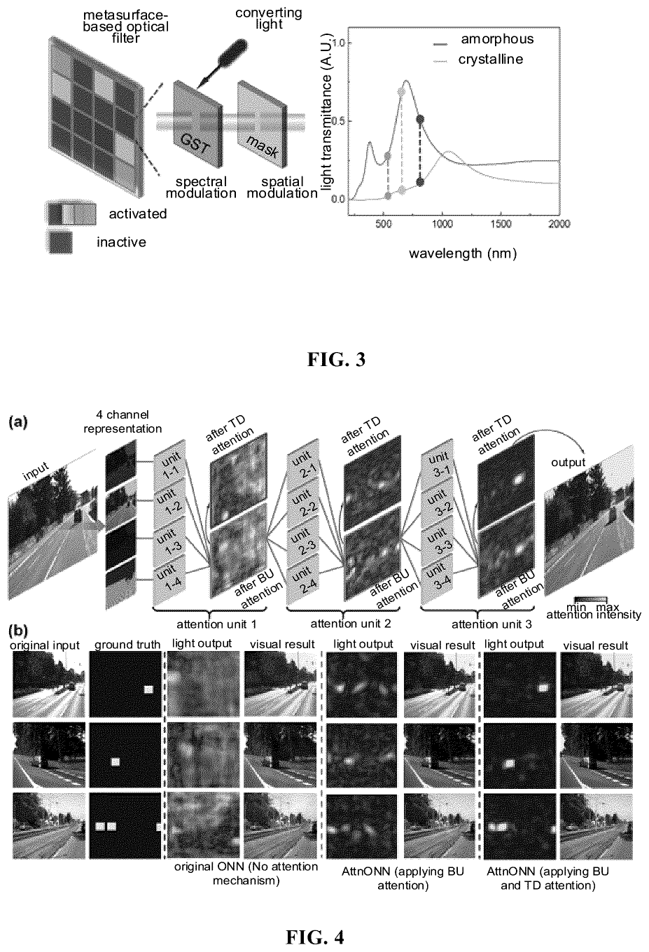

FIG. 3 illustrates the structure of the metasurface-based optical filter. As illustrated in FIG. 3, each unit consists of two layers of thin film, the first layer is GeSbTe (GST) of 2×2 μm grown on a transparent silicon substrate, and the second layer is an intensity mask. GST has two states (i.e., amorphous state and crystalline state) corresponding to different transmittance spectrums, and the two states may be switched instantaneously by switching light. The intensity mask unit is based on a digital micromirror device (DMD) applied for spatial modulation. In an example, for the nonlinear activation function in network propagation, a photorefractive crystal (i.e., SBN: 60) is used as an optical nonlinear layer in the disclosure. The SBN: 60 may adaptively change its refractive index in response to a change in the distribution of light intensity, to provide all-optical activation function calculation in the connections between optical neurons. It is understandable that the metasurface-based optical filter in FIG. 3 is based on the phase-change material (GST) and an intensity mask. The adaptive spectral modulation is realized by switching between different states through the phase change of the GST unit, while the spatial modulation is realized by switching between the on and off states of the intensity mask.

In an embodiment of the disclosure, assuming that U_{bu1}ⁱ is an input light field of the BU1 at the ith wavelength, in a 2f system under the coherent light, the input is subjected to the Fourier transform: Ũ_{bu1}ⁱ=FU_{bu1}ⁱ, in which Û represents the optical feature in the Fourier domain, and F represents the Fourier transform matrix. The feature is further transformed as Û_{bu1}ⁱ=T_{bu1}Ũ_{bu1}ⁱ, where Û represents the transformed attentional feature, and T represents the executed complex transformation matrix. Each attention layer performs diffraction-based propagation and transfers the feature as input to the next layer. The final output O_{bu1}ⁱ is obtained and transferred to the TD module and the BU2 for subsequent processing. Similarly, the input of the TD and the input of the first layer of the BU2 are transformed respectively as Û_{td}ⁱ=T_{td}FO_{bu1}ⁱ and Û_{bu2}ⁱ=T_{bu2}FO_{bu1}ⁱ. Û_{td}_{^{k}}ⁱ is used to represent the feature in the kth layer. Each layer of BU2 is simultaneously modulated by TD in the Fourier space as the propagation of TD:

Û_{bu2}_{^{k}}ⁱ=T_{bu2}_{^{k}}Ũ_{td}_{^{k}}ⁱIₖⁱ(Û_{td}_{^{k}}ⁱ)Mₖ(Û_{td}_{^{k}}ⁱ),
where Û_{bu2}_{^{k}}ⁱ represents the modulated BU2 attentional feature, and Iₖⁱ and Mₖ represent TD attention-determined spectral and spatial modulation functions, respectively, which adaptively prune and activate connections between optical neurons for sparse optical convolution. Given that the m-layer TD module and the m-layer BU2 and the spectrum is set to n wavelengths, the final output is calculated by a complex activation function, and another 2f system Fourier transform is applied to transform back to real space:

$$P = {\sum }_{i}^{n} {\vert F φ ( {\hat{U}}_{bu {2}^{m}}^{i} ) \vert}^{2} ,$$

where φ( ) represents a corresponding nonlinear function of a used photorefractive crystal, and P represents output of an entire framework.

During network training of an attention-aware optical neural network, input data is encoded in real time into complex light field information, and output is measured by the intensity sensor. A loss function is defined as:

$$L ( T ) = ‖ P - Γ ( G ) ‖ ;$$

where G represents a ground truth value and Γ represents a spatial inversion operation in which optical Fourier transform is performed twice, and a resulting loss is propagated backward to optimize spectral and spatial coefficients of BU and TD branches.

In the experiment, the disclosure applies 3 attention units with 9 layers of 800×800 optical neurons for evaluation (every 3 layers of the BU1, the TD optical attention module and the BU2 are defined as one attention unit), and each attention unit has a size of 2×2 μm. In addition to the attention neurons, in each layer, each spectral channel contains trainable diffractive neurons of size 800*800.

The aperture of the double 2f systems is set to match the size of the layer, so that the intensity sensor may better capture the output of the network. In the disclosure, the gap between layers is determined as 100 μm, which provides a more efficient use of space for network calculations. The number of network channels depends on input data structure, and a specific wavelength ranging from 500 to 1500 nm is assigned to each channel. In the disclosure, the intensity threshold is set to 0.3 for all intensity mask units, and an optical neuron with an intensity less than the intensity threshold is set to be inactive on the mask.

FIG. 4 is a schematic diagram illustrating performance evaluation of AttnONN on a target detection task. In FIG. 4, (a) is a reasoning process of the AttnONN for the target detection task and its operation process of projection-interference-prediction, and (b) shows a comparison of representative results based on different standards of an original ONN, an AttnONN with BU attention applied, and an AttnONN with BU and TD attention applied. It may be observed in the disclosure that the proposed system architecture may quickly and accurately detect a scene containing a single object or a scene containing multiple objects.

In an embodiment of the disclosure, the performance of the AttnONN on a challenging target detection task is evaluated based on a complex KITTI dataset. The experiment uses a subset of 2D objects where 7500 images are used for training and 2500 images are used for validation. The disclosure adjusts the image resolution from the original 1225×375 to 800×800 as network input, and 4-channel RGBD (red, green, blue and depth) representations are separated and encoded to wavelengths of 500 nm, 600 nm, 700 nm and 800 nm. As illustrated in (a) of FIG. 4, the disclosure converts and records attentional features during AttnONN's reasoning process for object detection. It may be seen that the BU attention flow at each layer generates a feature map of potential importance, and the TD attention flow modulates it to prominent regions of real attention, which corresponds well to the brain's attention mechanisms. After 3 attention units, the object (i.e., car) is accurately detected by localizing on the output plane a region of light signals that exceed the intensity threshold.

For comparison, the disclosure establishes a 9-layer 800×800 original ONN and an electron-based high-performance network, i.e., ResNet-18, that use the same configuration for learning. Representative detection results under different settings are illustrated in (b) of FIG. 4. The detection ground truth values are designed as bright squares on a blank background matching target locations on the original image. Compared with the original ONN, the BU optical attention module prunes the most redundant optical connections and preserves significant features, while the TD optical attention module further modulates attention to a region of interest and locates an object.

For accuracy assessment and quantification, the disclosure calculates a Precision Recall (PR) curve between detection results and ground truth values. The result shows that the accuracy of the AttnONN without BU and TD attention applied, the AttnONN with BU attention applied, and the AttnONN with BU and TD attention applied are 64.8%, 71.9%, and 79.0%, respectively. The peak performance of AttnONN is 39.8% greater than that of the original ONN.

The proposed AttnONN activates only 12.1% of optical neurons for light propagation, and has achieved more than 8 times the learning capacity compared to the original ONN using conventional dense connections, and its energy use efficiency is 2 orders of magnitude greater than that of electrical networks. In conclusion, the proposed system architecture obtains advantages brought by sparse optical convolution, which is the first time that an object is detected over real-world complex data by an ONN.

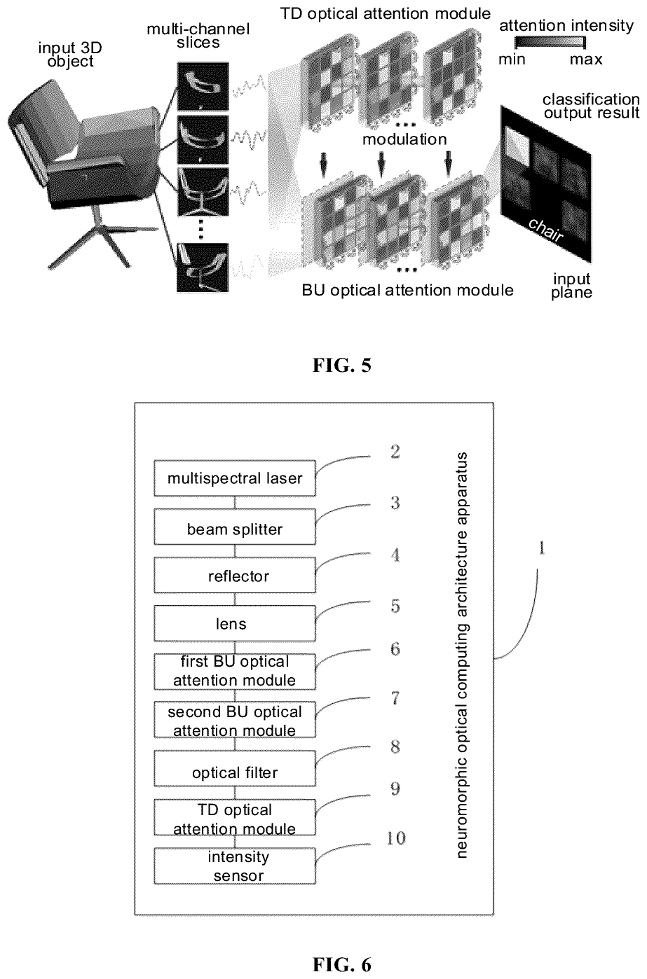

FIG. 5 illustrates a working process of the AttnONN for a 3D object classification task. Multichannel slices of 3D data are projected and encoded into the light field, which is processed by the BU and TD optical attention modules, and ultimately generates a classification pattern on the output plane.

In an embodiment of the disclosure, the disclosure further evaluates the performance of the proposed architecture on the 3D object classification task. FIG. 5 illustrates a reasoning operation process of the AttnONN on a ShapeNet dataset, which contains 55 common object categories and over 50000 3D models. In the disclosure, 5 categories are selected to form a subset for AttnONN function validation, and each input 3D model is cropped into l slices that are all adjusted to a resolution of 800×800, where l is set to 9 in the experiment. The multichannel input is encoded using 9 different wavelengths ranging from 600 to 1400 nm, which are separated every 100 nm. After propagation using the BU and TD optical attention modules, the classification outputs are obtained through measurement by a sensor that is set to a fixed pattern.

It is known that the disclosure adopts a quantization method for classification accuracy. It may be measured by the disclosure that the AttnONN may obtain higher accuracy when the number of channels is gradually increased. However, the accuracy of the original ONN decreases dramatically when l>5. The highest accuracy achieved by the AttnONN and the electron-based ResNet-18 reaches 93.8% and 94.3%, respectively, which proves that the proposed architecture has competitive performance on complex tasks. In all experiments, the AttnONN successfully exploits the inherent sparsity and parallelism of light, which provides significant optimization for optical computation.)

In conclusion, the proposed neuromorphic optical computing architecture system accomplishes attention-aware sparse learning and may run large-scale complex machine vision applications at light speed. The disclosure validates the high accuracy and high energy efficiency of the AttnONN on challenging object detection and 3D object classification tasks through various experiments. As an embedded system, the proposed system architecture may be fabricated and deployed into edge/terminal imaging systems including microscopes, cameras, and smartphones, to build more powerful optical computing systems for modern advanced machine intelligence.

The neuromorphic optical computing architecture system according to the embodiments of the disclosure is highly accurate and highly energy efficient on challenging object detection and 3D object classification tasks and may adaptively allocate computational resources, providing unprecedented capabilities and scalability, and optical neural networks are used to solve high complexity machine learning problems for the first time.

In order to realize the above embodiments, as illustrated in FIG. 6, a neuromorphic optical computing architecture apparatus 1 is provided in this embodiment. The apparatus 1 includes: a multispectral laser 2, a beam splitter 3, a reflector 4, a lens 5, a first BU optical attention module 6, a second BU optical attention module 7, an optical filter 8, a TD optical attention module 9, and an intensity sensor 10.

A target light field signal is input to the multispectral laser 2 to output coherent light having different wavelengths; diffraction-based light propagation of the coherent light having different wavelengths is guided using the beam splitter 3, the reflector 4 and the lens 5; after propagation, the TD optical attention module 9 takes a multidimensional sparse feature output by the first BU optical attention module 6 as input, processes the input and feeds back to the second BU optical attention module 7 to adjust the second BU optical attention module 7; the optical filter 8 is used to control connections between optical neurons in the second BU optical attention module 7 and perform spectral and spatial modulation on the optical neurons; and the intensity sensor 10 is used to detect and obtain a location of an object in a light field and an identification result based on light attention factors.

The neuromorphic optical computing architecture apparatus according to the embodiments of the disclosure is highly accurate and highly energy efficient on challenging object detection and 3D object classification tasks and may adaptively allocate computational resources, providing unprecedented capabilities and scalability, and optical neural networks are used to solve high complexity machine learning problems for the first time.

The neuromorphic optical computing architecture system and the neuromorphic optical computing architecture apparatus according to embodiments of the disclosure accomplish attention-aware sparse learning to adaptively allocate computational resources to run large-scale complex machine vision applications at light speed.

Reference throughout this specification to “an embodiment,” “some embodiments,” “an example,” “a specific example,” or “some examples,” means that a particular feature, structure, material, or characteristic described in combination with the embodiment or example is included in at least one embodiment or example of the disclosure. The appearances of the above phrases in various places throughout this specification are not necessarily referring to the same embodiment or example of the disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance or to implicitly specify the number of technical features indicated. Therefore, the feature defined with “first” and “second” may expressly or impliedly include at least one of the features. In the description of the disclosure, “a plurality of” means at least two, for example, two or three, unless specified otherwise.

What is claimed is:

1. A neuromorphic optical computing architecture system, comprising a multi-channel representation module, an attention-aware optical neural network module and an output module, wherein:
the multi-channel representation module is configured to encode, via a multi-spectral laser, an originally inputted target light field signal into coherent light having different wavelengths;
the attention-aware optical neural network module comprises: a bottom-up (BU) optical attention module and a top-down (TD) optical attention module, wherein the coherent light having different wavelengths is input to the BU optical attention module and network training is performed on an attention-aware optical neural network, and the TD optical attention module performs, based on the trained attention-aware optical neural network, spectral and spatial transmittance modulation of multi-dimensional sparse features extracted by the BU optical attention module to obtain a final spatial light output; and
the output module is configured to detect and identify the final spatial light output on an output plane to obtain a location of an object in a light field and an identification result.

2. The system of claim 1, wherein the BU optical attention module comprises a first BU optical attention module and a second BU optical attention module, the TD optical attention module takes output features of the first BU optical attention module as input, processes the input and feeds back to the second BU optical attention module to adjust the second BU optical attention module.

3. The system of claim 2, wherein to obtain output of the TD optical attention module, connections between optical neurons in the second BU optical attention module are controlled using a metasurface-based optical filter while performing spectral and spatial modulation on the optical neurons to obtain an optical neuron connection result and a modulation result; and
an intensity sensor detects and identifies the final spatial light output on an output plane based on the optical neuron connection result, the modulation result and an optical attention factor, to obtain a location of an object in a light field and an identification result.

4. The system of claim 1, wherein each unit of a metasurface-based optical filter consists of two layers of film, a first layer is a GeSbTe (GST) unit and a second layer is an intensity mask unit, the GST unit comprises an amorphous state and a crystalline state corresponding to different transmittance spectrums, and the amorphous state and the crystalline state are switched instantaneously by converting light.

5. The system of claim 2, wherein the BU optical attention module and the TD optical attention module are established by inserting a multilayer sparse optical convolution unit into a Fourier plane of a 4f optical system under the coherent light having different wavelengths; given that U_{bu1}ⁱ represents an input light field of the first BU optical attention module at a i^{th} wavelength, a first feature is obtained by performing Fourier transform on the input using a first 2f optical system under the coherent light:
Ũ_{bu1}ⁱ=FU_{bu1}ⁱ;
where Ũ represents an optical feature in a Fourier domain, and F represents a Fourier transform matrix; wherein the first feature is transformed into a second feature:
Û_{bu1}ⁱ=T_{bu1}Ũ_{bu1}ⁱ;
where Û represents a transformed attention feature, and T represents an executed complex transformation matrix; and
diffraction-based propagation is performed through the first BU optical attention module, the second feature is transmitted as input to a next layer to obtain output data O_{bu1}ⁱ, and the output data O_{bu1}ⁱ is transmitted to the TD optical attention module and the second BU optical attention module.

6. The system of claim 5, wherein inputs of the TD optical attention module and the second BU optical attention module are converted respectively by following equations:
Û_{td}ⁱ=T_{td}FO_{bu1}ⁱ;
Ûbu2ⁱ=T_{bu2}FO_{bu1}ⁱ;
where Û_{td}_{^{k}}ⁱ represents a feature of a k^{th} layer; based on propagation through the TD optical attention module, the TD optical attention module modulates each second BU optical attention module in a Fourier space:
Û_{bu2}_{^{k}}ⁱ=T_{bu2}_{^{k}}Ũ_{td}_{^{k}}ⁱIₖⁱ(Û_{td}_{^{k}}ⁱ)Mₖ(Û_{td}_{^{k}}ⁱ);
where Û_{bu2}_{^{k}}ⁱ represents a modulated attention feature of the second BU optical attention module, and Iₖⁱ and Mₖ represent a spectral modulation function and a spatial modulation function decided by the TD optical attention module respectively; and
given that the TD optical attention module and the second BU optical attention module each consist of m layers and a spectrum is set to n wavelengths, to compute a final spatial light output by means of an activation function, the final spatial light output is transformed to a real space through the Fourier transform by means of a second 2f optical system:
$$P = {\sum }_{i}^{n} {\vert F φ ( {\hat{U}}_{bu {2}^{m}}^{i} ) \vert}^{2} ;$$
where φ( ) represents a corresponding nonlinear function of a used photorefractive crystal, and P represents output of an entire framework.

7. The system of claim 1, wherein a loss function used in network training of the attention-aware optical neural network is defined as:
$$L ( T ) = ‖ P - Γ ( G ) ‖ ;$$
where G represents a ground truth value and Γ represents a spatial inversion operation in which optical Fourier transform is performed twice, and a resulting loss is propagated backward to optimize spectral and spatial coefficients of BU and TD branches.

8. The system of claim 2, wherein every 3 layers of the first BU optical attention module, the TD optical attention module and the second BU optical attention module are defined as one attention unit, each attention unit has a size of 2*2 μm, and in each layer, each spectral channel contains trainable diffractive neurons of size 800*800.

9. The system of claim 8, wherein a gap between layers of the first BU optical attention module, the TD optical attention module and the second BU optical attention module is set to 100 μm, a wavelength ranging from 500 to 1500 nm is assigned to each network channel, an intensity threshold of all intensity mask units is set to 0.3, and an optical neuron with an intensity less than the intensity threshold is set to be inactive.

10. A neuromorphic optical computing architecture apparatus, comprising a multispectral laser, a beam splitter, a reflector, a lens, a first bottom-up (BU) optical attention module, a second BU optical attention module, an optical filter, a top-down (TD) optical attention module, and an intensity sensor, wherein:
a target light field signal is input to the multispectral laser to output coherent light having different wavelengths; diffraction-based light propagation of the coherent light having different wavelengths is guided using the beam splitter, the reflector and the lens; after propagation, the TD optical attention module takes a multidimensional sparse feature output by the first BU optical attention module as input, processes the input and feeds back to the second BU optical attention module to adjust the second BU optical attention module; the optical filter is used to control connections between optical neurons in the second BU optical attention module and perform spectral and spatial modulation on the optical neurons; and the intensity sensor is used to detect and obtain a location of an object in a light field and an identification result based on light attention factors.

11. The apparatus of claim 10, wherein the optical filter is a metasurface-based optical filter, each unit of the metasurface-based optical filter consists of two layers of film, a first layer is a GeSbTe (GST) unit and a second layer is an intensity mask unit, the GST unit comprises an amorphous state and a crystalline state corresponding to different transmittance spectrums, and the amorphous state and the crystalline state are switched instantaneously by converting light.

12. The apparatus of claim 10, wherein the first BU optical attention module, the second BU optical attention module and the TD optical attention module are established by inserting a multilayer sparse optical convolution unit into a Fourier plane of a 4f optical system under the coherent light having different wavelengths; given that U_{bu1}ⁱ represents an input light field of the first BU optical attention module at a i^{th} wavelength, a first feature is obtained by performing Fourier transform on the input using a first 2f optical system under the coherent light:
Ũ_{bu1}ⁱ=FU_{bu1}ⁱ;
where Ũ represents an optical feature in a Fourier domain, and F represents a Fourier transform matrix; wherein the first feature is transformed into a second feature:
Û_{bu1}ⁱ=T_{bu1}Ũ_{bu1}ⁱ;
where Û represents a transformed attention feature, and T represents an executed complex transformation matrix; and
diffraction-based propagation is performed through the first BU optical attention module, the second feature is transmitted as input to a next layer to obtain output data O_{bu1}ⁱ, and the output data O_{bu1}ⁱ is transmitted to the TD optical attention module and the second BU optical attention module.

13. The apparatus of claim 12, wherein inputs of the TD optical attention module and the second BU optical attention module are converted respectively by following equations:
Û_{td}ⁱ=T_{td}FO_{bu1}ⁱ;
Û_{bu2}ⁱ=T_{bu2}FO_{bu1}ⁱ;
where Û_{td}_{^{k}}ⁱ represents a feature of a k^{th} layer; based on propagation through the TD optical attention module, the TD optical attention module modulates each second BU optical attention module in a Fourier space:
Û_{bu2}_{^{k}}ⁱ=T_{bu2}_{^{k}}Ũ_{td}_{^{k}}ⁱIₖⁱ(Û_{td}_{^{k}}ⁱ)Mₖ(Û_{td}_{^{k}}ⁱ);
where Û_{bu2}_{^{k}}ⁱ represents a modulated attention feature of the second BU optical attention module, and Iₖⁱ and Mₖ represent a spectral modulation function and a spatial modulation function decided by the TD optical attention module respectively; and
given that the TD optical attention module and the second BU optical attention module each consist of m layers and a spectrum is set to n wavelengths, to compute a final spatial light output by means of an activation function, the final spatial light output is transformed to a real space through the Fourier transform by means of a second 2f optical system:
$$P = {\sum }_{i}^{n} {\vert F φ ( {\hat{U}}_{bu {2}^{m}}^{i} ) \vert}^{2} ;$$
where φ( ) represents a corresponding nonlinear function of a used photorefractive crystal, and P represents output of an entire framework.

14. The apparatus of claim 10, wherein every 3 layers of the first BU optical attention module, the TD optical attention module and the second BU optical attention module are defined as one attention unit, each attention unit has a size of 2*2 μm, and in each layer, each spectral channel contains trainable diffractive neurons of size 800*800.

15. The apparatus of claim 14, wherein a gap between layers of the first BU optical attention module, the TD optical attention module and the second BU optical attention module is set to 100 μm.
